(19) United States
(12) Patent Application Publication
(10) Pub. No.: US 2011/0004500 A1
(43) Pub. Date: Jan. 6, 2011

(54) ALLOCATING A RESOURCE BASED ON QUALITY-OF-SERVICE CONSIDERATIONS

(75) Inventor: Ripal B. Nathuji, Bothell, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/497,702

(22) Filed: Jul. 6, 2009

(51) Int. Cl. G06F 1/26; G06Q 10/00

(52) U.S. Cl. 705/7; 713/340

(57) ABSTRACT

A system is described for allocating a resource (such as available power) among components (such as virtual machines) within a computing environment (such as a data center). The system allocates the resource by taking account of both a system-wide consumption budget and the prevailing quality-of-service expectations of the components. The system distributes its management functionality between a main control module and agents provided in one or more components (e.g., virtual machines). The main control module includes a budget controller, while each component includes a bid-generation controller. A main resource manager module (within the main control module) generates allocations of resource based on an output of the budget controller and bids provided by respective bid-generation controllers.

### BACKGROUND

Advances in computing technology have allowed data centers to make increasingly efficient use of their available space. However, there are other factors which have a bearing on the manner in which processing functionality is provisioned within a data center, such as power-related considerations and cooling-related considerations. These factors may limit the viable density of processing functionality within a data center.

Data centers commonly use virtualization strategies to more effectively manage the consumption of a resource (such as power) within a data center. The processing functionality associated with a virtual machine maps to a pool of physical resources in a dynamic manner. There nevertheless remains room for improvement in the management of resources within data centers and other computing environments.

### SUMMARY

According to one illustrative implementation, a system is described for allocating a resource (such as available power) among components (such as virtual machines) within a computing environment (such as a data center). The system allocates the resource by taking account of both a system-wide consumption budget and the prevailing quality-of-service expectations of the components. In one case, the system operates by allocating an amount of the resource foregone by one or more components to one or more other components. Such “recipient” components express a higher need for the resource compared to the “donor” components.

According to one illustrative aspect, the system distributes its resource management operation between a main control module and agents provided in one or more components (e.g., virtual machines). The main control module can include a budget controller which determines a total of amount of the resource that is available to the computing environment on the basis of the consumption budget and a resource measurement (e.g., a power measurement). The system can implement the budget controller as a closed-loop controller, such as a proportional-integral-derivative (PID) controller. A main resource manager module generates allocations of resource (e.g., power caps) based on the total amount of resource provided by the budget controller, along with bids provided by the individual components. Each bid expresses a request, made by a corresponding component, for an amount of the resource.

According to another illustrative aspect, each component provides a bid-generation controller. The system can implement the bid-generation controller as a closed-loop controller, such as a proportional-integral-derivative (PID) controller. The bid-generation controller generates a bid for use by the main resource manager module based on a willingness value and a price. The willingness value reflects an assessed need for the resource component, which, in turn, is based on quality-of-service expectations of the component. The price reflects congestion or overheads associated with allocating power to the component, as conveyed by the main resource manager.

According to another illustrative aspect, a virtual machine management module (such as hypervisor functionality) can apply the allocations of resource identified by the main resource manager module. In one implementation, the allocations of resource correspond to power caps that govern the operation of virtual processors associated with virtual machines.

The above approach can be manifested in various types of systems, components, methods, computer readable media, data structures, articles of manufacture, and so on.

This Summary is provided to introduce a selection of concepts in a simplified form; these concepts are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 shows an illustrative system for managing a resource in a computing environment.

FIG. 2 shows two illustrative agent modules that can be used within the system of FIG. 1.

FIG. 3 shows an illustrative proportional-integral-derivative (PID) controller that can be used in the system of FIG. 1.

FIG. 4 shows a main resource manager module that can be used in the system of FIG. 1.

FIG. 5 shows an illustrative procedure which provides an overview of the operation of the system of FIG. 1.

FIG. 6 shows an illustrative procedure which explains the operation of the system of FIG. 1 from the perspective of a main control module.

FIG. 7 shows an illustrative procedure which explains the operation of the system of FIG. 1 from the perspective of an agent provided in a virtual machine.

FIG. 8 shows an illustrative procedure for determining allocations of resource (e.g., power caps) within the procedure of FIG. 6.

FIG. 9 shows an illustrative procedure for determining prices for dissemination to virtual machines within the procedure of FIG. 6.

FIG. 10 shows illustrative processing functionality that can be used to implement any aspect of the features shown in the foregoing drawings.

FIG. 11 shows a data center, which represents one illustrative computing environment that can be managed using the system of FIG. 1.

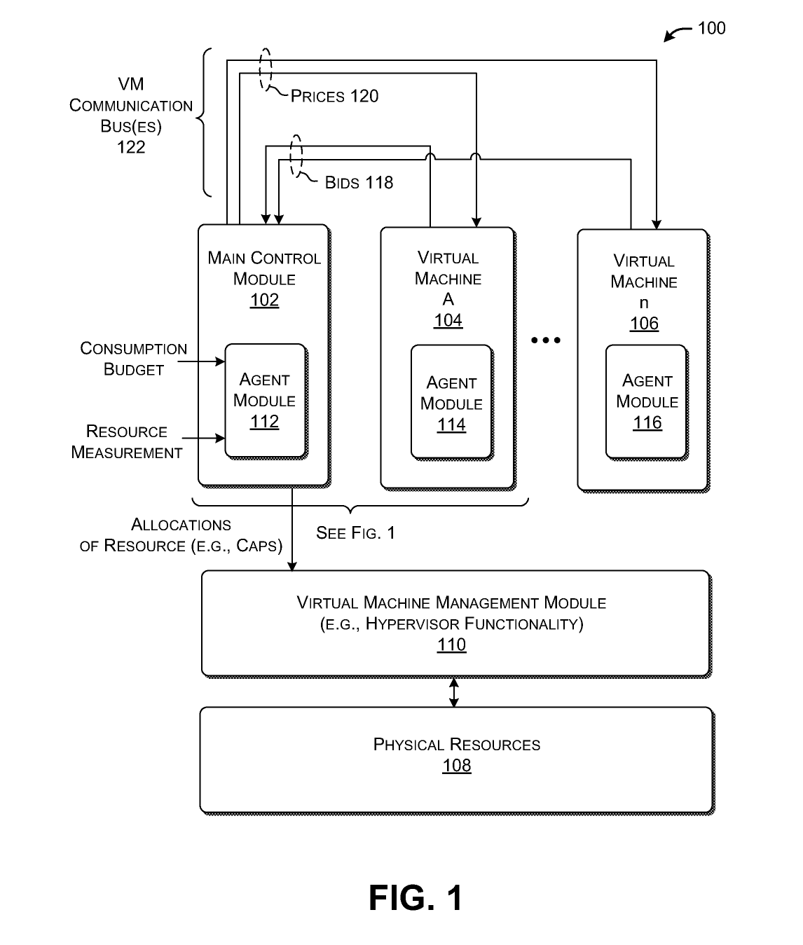

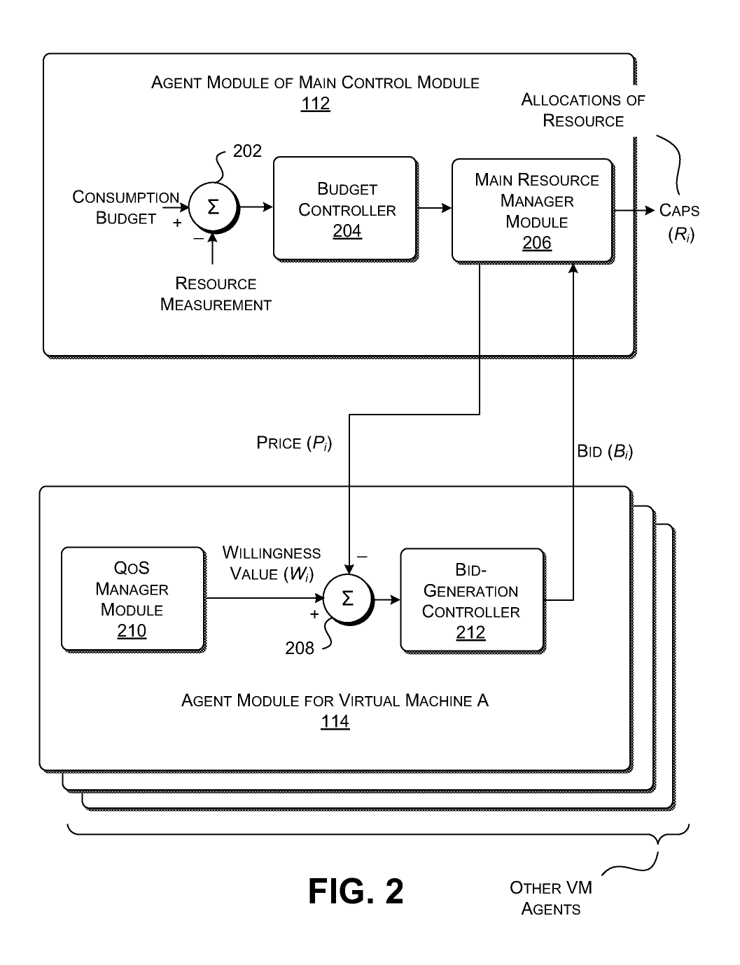

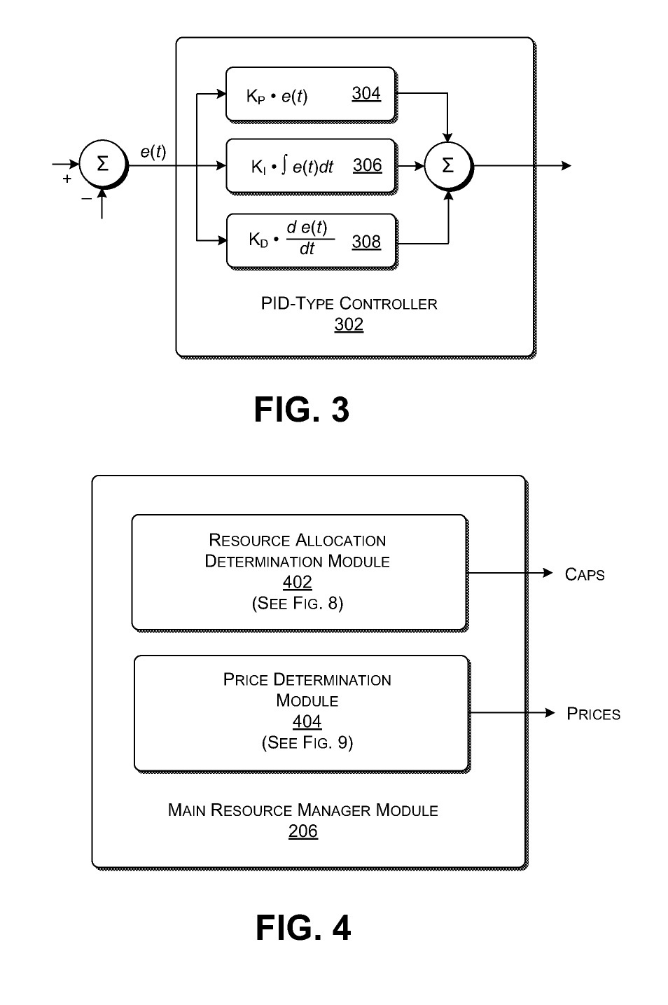

The same numbers are used throughout the disclosure and figures to reference like components and features. Series 100 numbers refer to features originally found in FIG. 1, series 200 numbers refer to features originally found in FIG. 2, series 300 numbers refer to features originally found in FIG. 3, and so on.

### DETAILED DESCRIPTION

This disclosure sets forth functionality for managing a resource within a computing system by taking account of a system-wide consumption budget and quality-of-service considerations associated with components within the computing environment. The functionality can use a distributed control strategy, including a budget controller in a main control module and bid-generation controllers in respective components.

This disclosure is organized as follows. Section A describes an illustrative system for allocating a resource within a computing environment. Section B describes illustrative methods which explain the operation of the system of Section A. Section C describes illustrative processing functionality that can be used to implement any aspect of the features described in Sections A and B.

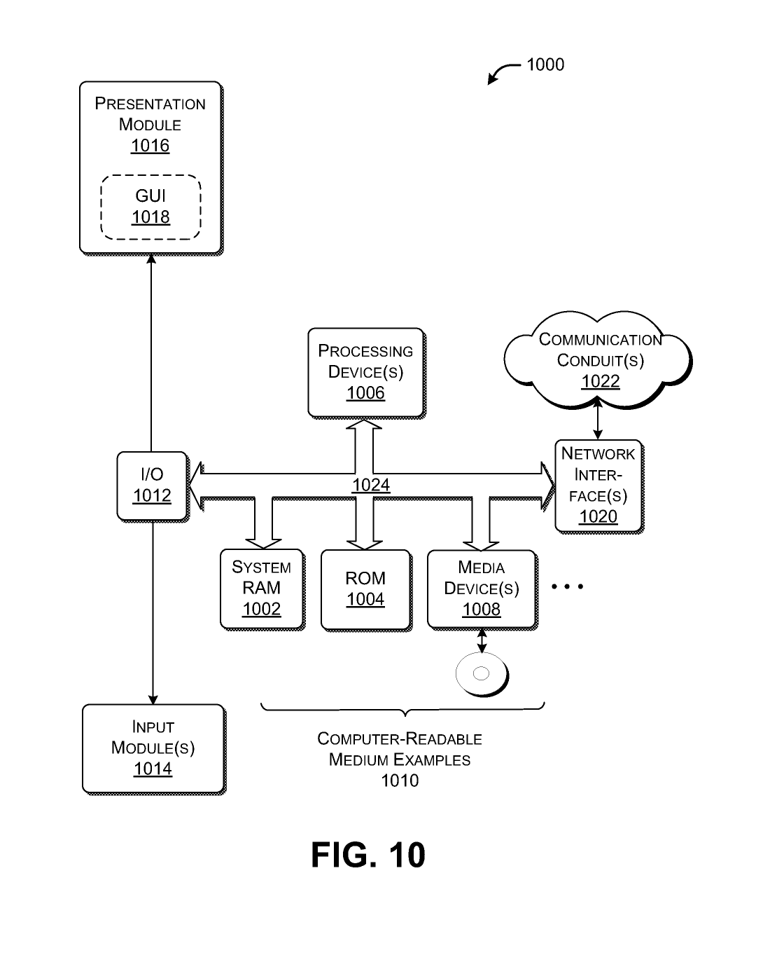

As a preliminary matter, some of the figures describe concepts in the context of one or more structural components, variously referred to as functionality, modules, features, elements, etc. The various components shown in the figures can be implemented in any manner, for example, by software, hardware (e.g., discrete logic components, etc.), firmware, and so on, or any combination of these implementations. In one case, the illustrated separation of various components in the figures into distinct units may reflect the use of corresponding distinct components in an actual implementation. Alternatively, or in addition, any single component illustrated in the figures may be implemented by plural actual components. Alternatively, or in addition, the depiction of any two or more separate components in the figures may reflect different functions performed by a single actual component. FIG. 10, to be discussed in turn, provides additional details regarding one illustrative implementation of the functions shown in the figures.

Other figures describe the concepts in flowchart form. In this form, certain operations are described as constituting distinct blocks performed in a certain order. Such implementations are illustrative and non-limiting. Certain blocks described herein can be grouped together and performed in a single operation, certain blocks can be broken apart into plural component blocks, and certain blocks can be performed in an order that differs from that which is illustrated herein (including a parallel manner of performing the blocks). The blocks shown in the flowcharts can be implemented by software, hardware (e.g., discrete logic components, etc.), firmware, manual processing, etc., or any combination of these implementations.

As to terminology, the phrase “configured to” encompasses any way that any kind of functionality can be constructed to perform an identified operation. The functionality can be configured to perform an operation using, for instance, software, hardware (e.g., discrete logic components, etc.), firmware etc., and/or any combination thereof.

The term “logic” encompasses any functionality for performing a task. For instance, each operation illustrated in the flowcharts corresponds to logic for performing that operation. An operation can be performed using, for instance, software, hardware (e.g., discrete logic components, etc.), firmware, etc., and/or any combination thereof.

A. Illustrative Systems

FIG. 1 shows an illustrative system 100 for managing the allocation of a resource within a computing environment. To facilitate explanation, the system 100 will be described in the context of the management of the allocation of power in a data center. Here, the resource corresponds to power and the computing environment corresponds to a data center. However, the principles described herein are not limited to this illustrative context. In other cases, the system 100 can be used to allocate any type of resource in any other type of contextual setting. For example, the principles described herein can be used to allocate memory capacity within any type of computer system.

The system 100 includes a main control module 102 which operates to manage the allocation of power to other components within the system. In one particular (but non-limiting) implementation, the components correspond to respective virtual machines, such as virtual machine A 104 and virtual machine n 106. Although two virtual machines are shown for simplicity, the system 100 can include any number of virtual machines. A virtual machine corresponds to functionality for hosting one or more applications by dynamically drawing on a pool of physical resources 108. Other virtual machines may draw from the same physical resources 108. Each virtual machine may optionally also host its own operating system using the physical resources 108. A virtual machine management module 110 coordinates (e.g., schedules) the interaction between virtual machines (104, 106) and the physical resources 108.

The system 100 can be built using any underlying virtualization technology. In one approach, the system 100 is divided into a number of partitions or domains. The main control module 102 can be implemented by a root partition, while the virtual machines (104, 106) can be implemented by respective guest partitions. The virtual machine management module 1 10 can be implemented using hypervisor technology.

The system 100 will be described in the context of the above-described virtual machine environment to facilitate explanation by providing concrete examples. However, the principles described herein are not limited to this environment. In another implementation, the components of the system 100 correspond to respective physical machines (instead of virtual machines). The physical machines may have a fixed (one-to-one) relationship with their constituent resources.

Each component of the system 100 includes an agent for implementing a part of the management operations performed by the system 100. For example, the main control module 102 includes an agent module 112, virtual machine A 104 includes an agent module 114, and virtual machine n 106 includes an agent module 116. More specifically, the system 100 adopts a distributed manner of controlling the allocation of power. The agent module 112 of the main control console 102 performs a main part of the management operation, while the agent modules (114, 116) of the respective virtual machines (104, 106) perform complementary management operations. The agent modules (114, 116) provide results which feed into the main management operation performed by the agent module 112 of the main control module 102.

Consider first an overview of the management operations performed by the agent module 112 of the main control module 102. This module determines an amount of power for allocation to each individual virtual machine. In making this determination, the agent module 112 takes into consideration a consumption budget and a resource measurement. The consumption budget reflects a budgeted amount of power available to the system 100 as a whole. The resource measurement reflects a measurement of a total amount of power currently being consumed by the system 100 as a whole. In addition, the agent module 112 takes into consideration a series of bids 118 received from the agents modules (114, 116) of the respective virtual machines (104, 106). The bids 118 reflect requests by the virtual machines for certain amounts of powers.

Consider next an overview of the operation performed by each virtual machine, such as by the agent module 114 of the virtual machine A 104. This module receives a price from the agent module 112 of the main control module 102. The price reflects system-wide congestion and overheads associated with the current allocation of power to the virtual machine A 104. Collectively, the price is part of a collection of prices 120 sent to the virtual machines (104, 106) by the agent module 112. The agent module 114 of virtual machine A 104 also receives a willingness value. The willingness value reflects an assessment, by the agent module 114, of a need for a certain amount of power by the virtual machine A 104. This assessment, in turn, is based on quality-of-service (QoS) expectations of the virtual machine A 104. Based on these considerations (the price and the willingness value), the agent module 114 of the virtual machine generates a bid and forwards that bid to the agent module 112 of the main control module 102. That bid reflects a request by the agent module 114 (of virtual machine A 104) for a certain amount of power to accommodate the quality-of-service expectations of the services which it provides.

In one case, one or more buses 122 can be used to communicate the prices 120 from the main control module 102 to the virtual machines (104, 106), and to communicate the bids 118 from the virtual machines (104, 106) to the main control module 102. For example, using common virtualization terminology, a VMBus or the like can be used to exchange the above-described information.

Taken together, the management strategy employed by the system 100 serves two integrated roles. First, the management strategy seeks to maintain the overall (system-wide) consumption of power within the system 100 within the limit established by the consumption budget. This operation yields, at any given time, an indication of a total amount of power that is available for distribution among the virtual machines (104, 106). At the same time, the management strategy seeks to allocate the available power to the virtual machines (104, 106) based on the quality-of-service expectations of the individual virtual machines (104, 106). In operation, some of the virtual machines may provide bids which reflect a relatively low need for power. In other words, these virtual machines provide bids which reflect a need for power that is below a fair share of power to which they are entitled (where the concept of “fair share” will be described in greater detail below). One or more other virtual machines may provide bids which reflect a higher need for power. These virtual machines provide bids which reflect a need for power above the fair share amount of power. Generally speaking, the management strategy seeks to transfer power from those virtual machines that have low resource needs and apply it to those virtual machines with higher resource needs. This has the dual benefit of efficiently managing a total amount of power that is available while simultaneously addressing the varying needs of different applications (if deemed possible).

Consider an illustrative example. Suppose that virtual machine A 104 runs an application with high quality-of-service expectations, such as a network-implemented messaging service used by a law enforcement agency. Suppose that virtual machine n 106 runs an application with low quality-of-service expectations, such a batch processing routine that performs a backend accounting operation. Virtual machine n 106 may prepare a bid that reflects a desire to receive less power than the fair share amount of power to which it is entitled, while virtual machine A 104 may prepare a bid that reflects a desire to receive more power than the fair share amount. The management strategy can take these varying needs into account and disproportionally award more power to virtual machine A 104 compared to virtual machine n 106, while simultaneously attempting to satisfy an overall consumption budget. In effect, the extra power “donated” by virtual machine n 106 is applied to virtual machine A 104.

The system 100 can allocate power (or some other resource) among the virtual machines (104, 106) based on any expression of power. In one illustrative case, the agent module 112 parses the total amount of power into respective power caps. Each power cap defines a maximum amount of power that constrains the operation of a virtual machine. Still more particularly, consider the case in which each virtual machine is associated with one or more virtual processors (VPs). The virtual processors correspond to virtual processing resources that are available to the virtual machine, where each virtual processor may map to one or more physical processors (e.g., physical CPUs) in a dynamic manner. In one approach, a power cap defines a maximum amount of power that constrains the operation of a virtual processor. By limiting the power expenditure of a virtual processor, the management strategy employed by the system 100 indirectly limits the amount of power consumed by physical processors within the system 100. In one particular case, the agent module 112 can assign a power cap to a virtual machine, and that power cap sets a limit with respect to each virtual processor employed by the virtual machine. To repeat, the above example is illustrative and non-limiting; other systems may partition available power among the virtual machines using other ways of expressing power.

FIG. 2 shows a more detailed view of the agent module 112 used in the main control module 102 and the agent module 114 used in virtual machine A 104. Although not shown, each of the other virtual machines can include an agent module that has the same (or similar) components compared to agent module 114. As described above, the system 100 implements a distributed management strategy. In this approach, the agent module 112 performs the central role of allocating power among the virtual machines (104, 106). Agent module 114 contributes to the allocation management operation by supplying a bid to the agent module 112 which reflects a request for a certain amount of power, as governed, in turn, by the quality-of-service expectations of the virtual machine A 104.

By way of overview, the components shown in FIG. 2 establish two types of control loops operations. The agent module 112 performs a main control loop operation to establish resource allocations (e.g., power caps). Each agent module associated with a virtual machine performs another control loop operation to provide a bid. The operations performed by the control loops are repeated for each management interval, such as, in one merely illustrative case, one second. The following explanation describes the operations performed by the control loops over the course of a single management interval.

Consider first the operation of the agent module 112. The agent module 112 includes a combination module 202 which determines an error between the consumption budget and the resource measurement. To repeat, the consumption budget defines a budgeted amount of power for use by the system 100, while the resource measurement corresponds to a measurement of the amount of power currently being consumed by the system 100.

A budget controller 204 processes the error provided by the combination module 202 and provides an output based thereon. In one case, the budget controller 204 uses a closed-loop control approach to generate the output. In yet a more particular case, the budget controller 204 uses a proportional-integral-derivative (PID) approach to generate the output. FIG. 3, to be discussed in turn, shows an illustrative proportional-integral-derivative control mechanism that can be used to implement the budget controller 204.

The output of the budget controller 204 is representative of a total amount of power T available for distribution to the virtual machines (104, 106). In one case, this total amount of power can be expressed as a sum of power caps for distribution to the virtual machines (104, 106). The budget controller 204 generally operates to close the gap represented by the error (reflecting the difference between the consumption budget and the resource measurement). That is, the budget controller 204 operates to reduce the total amount of power T when there is a positive error, and increase the total amount of power T when there is a negative error.

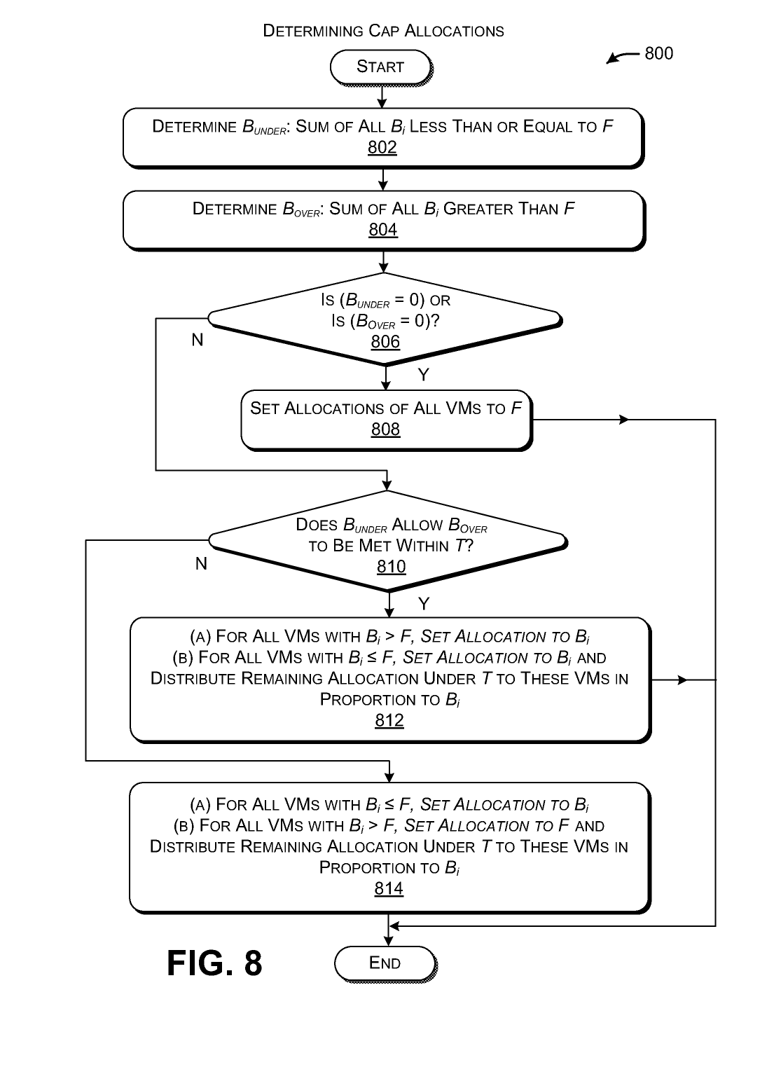

A main resource manager module 206 performs the principal role of dividing up the total amount of power T for distribution to individual virtual machines. It makes this decision based on two considerations. One consideration is the value of the total amount of power T itself. Another consideration relates to the bids received from the individual virtual machines. Based on these considerations, the main resource manager module 206 outputs allocations of resource Rᵢ. In one implementation, these allocations can take the form of power caps. The power caps may establish constraints which govern the operation of virtual processors employed by the virtual machines. FIG. 8, to be discussed below in turn, shows one algorithm that can be used to allocate power caps among the virtual machines.

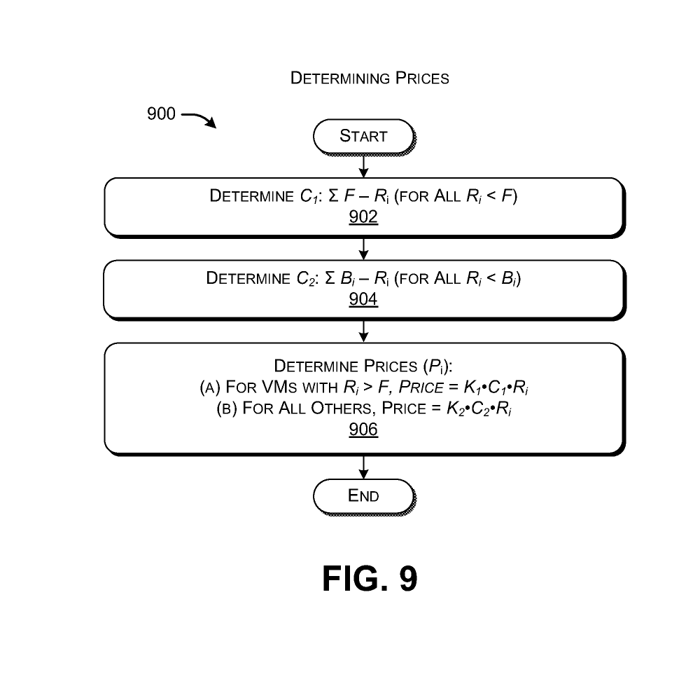

According to another function, the main resource manager module 206 computes prices and conveys the prices to the respective virtual machines (104, 106). Each price reflects congestion or overheads associated with allocating power to a corresponding virtual machine. FIG. 9, to be described below in turn, shows one algorithm that can be used to assign prices to the virtual machines (104, 106).

Now turning to the agent module 114 provided by virtual machine A 104, this module includes a combination module 208. The combination module 208 generates an error which reflects the difference between a willingness value (Wᵢ) and a price (Pᵢ) received from the agent module 112. The willingness value reflects a need for an amount of power by the virtual machine A 104, which, in turn, may reflect the quality-of-service expectations of the virtual machine A 104. In one implementation, a QoS manager module 210 provides the willingness value based on any consideration. In one case, the QoS manager module 210 can provide a static willingness value which expresses the power-related needs of the virtual machine A 104. In another case, the QoS manager module 210 can provide a dynamic willingness value which expresses a changing assessment of the amount of power desired by the virtual machine A 104. To repeat, the price (Pᵢ) relates to congestion or overheads associated with allocating power to virtual machine A 104.

A bid-generation controller 212 receives the error provided by the combination module 208 to generate a bid (Bᵢ), which is, in turn, fed back to the main resource manager module 206 of the agent module 112. In one case, the bid-generation controller 212 uses a closed-loop control approach to generate its output. In yet a more particular case, the bid-generation controller 212 uses a proportional-integral-derivative (PID) approach to generate the output. FIG. 3, to be discussed in turn, shows an illustrative proportional-integral-derivative control mechanism that can be used to implement the bid-generation controller 212.

In general, the bid-generation controller 212 seeks to reduce the error that represents the difference between the willingness value and the price forwarded by the agent module 112. During periods of congestion, a virtual machine is optimized when it is charged a price that is equivalent to its willingness value.

Advancing to FIG. 3, this figure shows a proportional-integral-derivative (PID) controller 302 that can be used to implement the controllers of FIG. 2; that is, a first PID controller can be used to implement the budget controller 204 and a second PID controller can be used to implement the bid-generation controller 212. In the context of the budget controller 204, the PID controller 302 receives an error e(t) that reflects the difference between the consumption budget and the resource measurement. In the context of the bid-generation controller 212, the PID controller 302 receives an error e(t) that reflects the difference between a price value and the willingness value. The PID controller 302 includes a proportional component 304 which reacts to a current value of the error. The PID controller 302 includes an integral component 306 which accounts for a recent history in error. The PID controller 302 includes a differential component 308 which accounts for a recent change in error. These components (304, 306, 308) generate respective outputs. A weighted sum of these outputs is used to generate a sum of power caps (in the case of the agent module 112 of the main control module 102) and a bid value (in the case of the agent module 114 of virtual machine A 104).

The PID controller 302 can be converted to a modified PID controller (e.g. a PI controller, PD controller, P controller, etc.) by setting any one or more of the weights (K_{P}, K_{I}, K_{D}) used by the respective components (304, 306, 308) to zero.

FIG. 4 provides a high-level summary of the main resource manager module 206 used in the agent module 112 of the main control module 102. The main resource manager module 206 includes a resource allocation determination module 402 for determining the power caps for application to the virtual machines (104, 106). FIG. 8 provides detailed information regarding the illustrative operation of this component. The main resource manager module 206 also includes a price determination module 404 for determining prices for distribution to the agent modules (114, 116) of the virtual machines (104, 106). FIG. 9 provides detailed information regarding the illustrative operation of this module.

B. Illustrative Processes

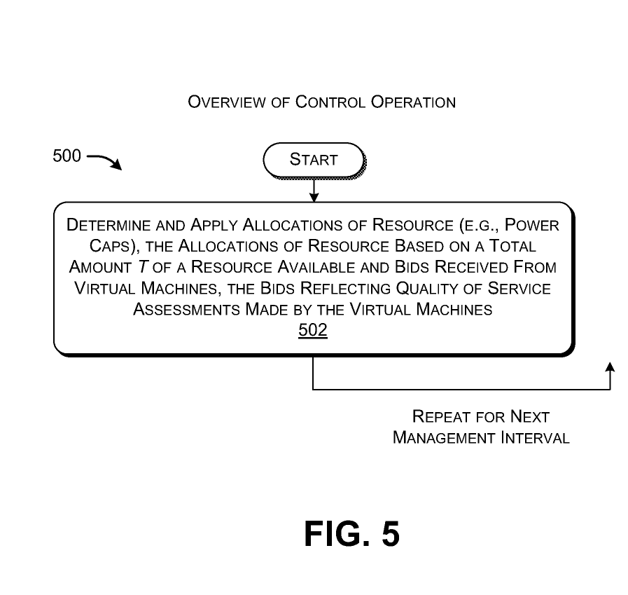

FIGS. 5-9 show procedures that explain the operation of the system 100 of FIG. 1. Since the principles underlying the operation of the system 100 have already been described in Section A, certain operations will be addressed in summary fashion in this section.

Starting with FIG. 5, this figure shows a procedure 500 which presents a broad overview of the operation of the system 100. In the sole block 502, the system 100 determines and applies allocations of resources (e.g., power caps) to the virtual machines. The power caps are based on a total amount of resource T available and bids received from the virtual machines. The bids reflect quality-of-service assessments made by the virtual machines. Block 502 is repeated over a series of successive management intervals.

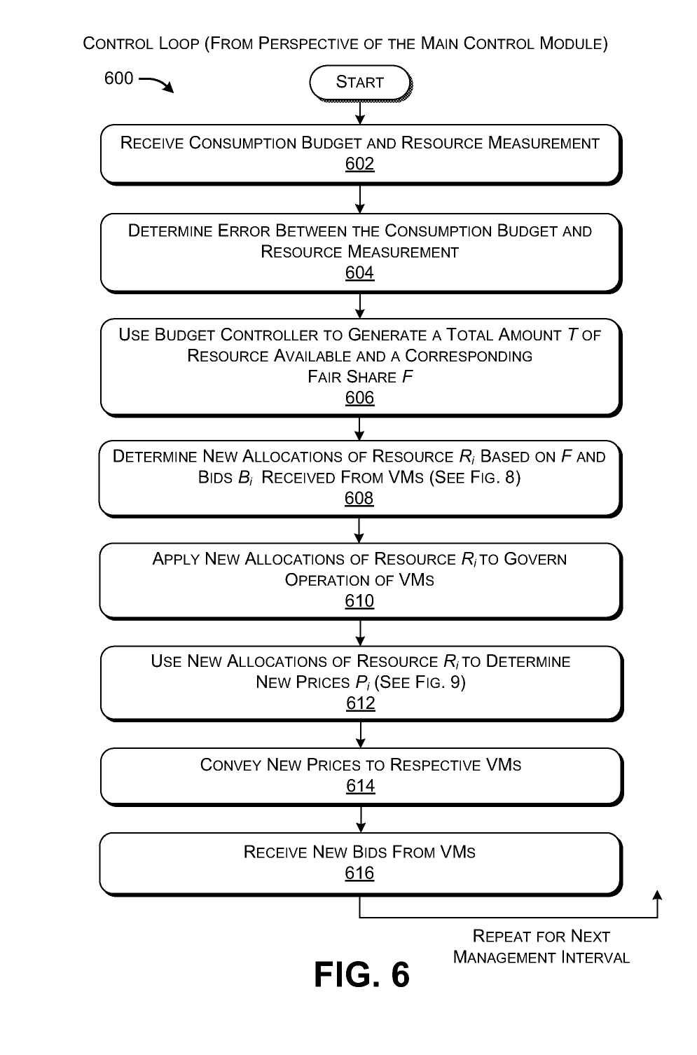

FIG. 6 shows a procedure 600 which represents the operation of the system 100 from the “perspective” of the agent module 112 of the main control module 102. This procedure 600 therefore represents the main part of the management strategy provided by the system 100.

In block 602, the agent module 112 receives a consumption budget (e.g., power budget) and resource measurement (e.g., power measurement).

In block 604, the agent module 112 determines an error between the consumption budget and the resource measurement.

In block 606, the agent module 112 uses the budget controller 204 to determine a total amount of power T that can be used by the virtual machines. The agent module 112 also determines a fair share F corresponding to a fair amount of power for distribution to the virtual machines. The fair share F generally represents that portion of T that can be allocated to the virtual machines under the premise that all virtual machines are to be considered as equally-deserving recipients of power. In yet a more particular example, suppose that there are N virtual processors employed by the virtual machines. The fair share F in this case may correspond to T divided by N. In practice, the value T can range from some non-zero value X to some value Y. e.g., 10×N to 100×N, where the multiplier of 10 for the lower bound is artificially chosen to ensure that no virtual machine is completely capped.

In block 608, the agent module 112 determines allocations of resource (Ri) (e.g., power caps) for allocation to the virtual machines based on the fair share F, as well as the bids Bᵢ received from the virtual machines.

In block 610, the agent module 112 applies the power caps (Rᵢ) that it has computed in block 608. In one case, the system 100 may rely on the virtual machine management module 110 (e.g., hypervisor functionality) to implement the power caps.

In block 612, the agent module 112 determines prices (Pᵢ) based on the power caps (Rᵢ).

In block 614, the agent module 112 conveys the prices to the respective virtual machines. The prices influence the bids generated by the virtual machines in the manner described above.

In block 616, the agent module 112 receives new bids (Bᵢ) from the virtual machines.

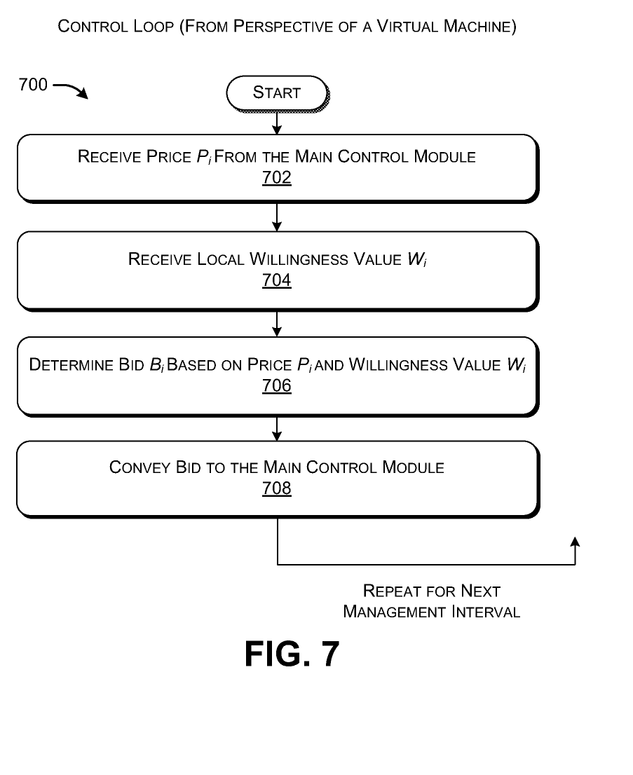

FIG. 7 shows a procedure 700 which represents the operation of the system 100 from the “perspective” of the agent module 114 of the virtual machine A 104. This procedure 700 therefore represents the complementary part of the management strategy performed by the virtual machines within the system 100.

In block 702, the agent module 114 receives a price (Pᵢ) from the agent module 112 of the main control module 102.

In block 704, the agent module 114 receives a local willingness value (Wᵢ) which reflects the virtual machine's need for power (which, in turn, may reflect the quality-of-service expectations of the virtual machine A 104).

In block 706, the agent module 114 uses the bid-generation controller 212 to generate a bid based on the willingness value and the price.

In block 708, the agent module 114 conveys the bid to the agent module 112 of the main control module 102.

FIG. 8 shows an illustrative and non-limiting procedure 800 for use by the main resource manager module 206 in determining resource allocations (e.g., power caps) for the virtual machines.

In block 802, the main resource manager module 206 determines the value B_{under}, defined as the sum of all bids Bᵢ less than or equal to the fair share F.

In block 804, the main resource manager module 206 determines the value Bₒᵥₑᵣ, defined as the sum of all bids Bᵢ greater than the fair share F.

In block 806, the main resource manager module 206 asks whether B_{under} is zero or whether Bₒᵥₑᵣ is zero.

In block 808, if block 806 is answered in the affirmative, the main resource manager module 206 sets the power caps for all virtual machines to the fair share F.

In block 810, if block 806 is answered in the negative, the main resource manager module 206 asks whether the sum B_{under} allows the bids associated with Bₒᵥₑᵣ to be met within the total available power T.

In block 812, if block 810 is answered in the positive, then the main resource manager module 206 sets the power caps for all virtual machines with Bᵢ>F to the requested bids Bᵢ of these virtual machines. Further, the main resource manager module 206 sets the power caps for all virtual machines with Bᵢ≦F to Bᵢ; the main resource manager module 206 then distributes the remaining power allocation under T to this class of virtual machines in proportion to their individual bids Bᵢ.

In block 814, if block 810 is answered in the negative, then the main resource manager module 206 sets the power caps for all virtual machines with Bᵢ≦F to the requested bids Bᵢ. Further, the main resource manager module 206 sets the power caps for all virtual machines with Bᵢ>F to the fair share F; the main resource manager module 206 distributes the remaining allocation under T to this class of virtual machines in portion to Bᵢ.

FIG. 9 shows a procedure 900 for use by the main resource manager module 206 for determining the prices to distribute to the virtual machines.

In block 902, the main resource manager module 206 determines the value of C₁, corresponding to ΣF−Rᵢ for all Rᵢ<F.

In block 904, the main resource manager module 206 determines the value of C₂, corresponding to ΣBᵢ−Rᵢ for all Rᵢ<Bᵢ.

In block 906, the main resource manager module 206 determines the prices. Namely, for all virtual machines with Rᵢ>F, the price is set at K₁×C₁×R₁, where K₁ is a configurable constant parameter. For all other virtual machines, the price is set at K₂×C₂×Rᵢ, where K₂ is a configurable constant parameter.

C. Representative Processing Functionality

FIG. 10 sets forth illustrative electrical data processing functionality 1000 that can be used to implement any aspect of the functions described above. With reference to FIG. 1, for instance, the system 100 can be implemented by one or more computing modules, such as one or more processing boards or the like that implement any function (or functions). In this setting, the type of processing functionality 1000 shown in FIG. 10 can be used to implement any such computing module.

The processing functionality 1000 can include volatile and non-volatile memory, such as RAM 1002 and ROM 1004, as well as one or more processing devices 1006. The processing functionality 1000 also optionally includes various media devices 1008, such as a hard disk module, an optical disk module, and so forth. The processing functionality 1000 can perform various operations identified above when the processing device(s) 1006 executes instructions that are maintained by memory (e.g., RAM 1002, ROM 1004, or elsewhere). More generally, instructions and other information can be stored on any computer readable medium 1010, including, but not limited to, static memory storage devices, magnetic storage devices, optical storage devices, and so on. The term computer readable medium also encompasses plural storage devices. The term computer readable medium also encompasses signals transmitted from a first location to a second location, e.g., via wire, cable, wireless transmission, etc.

The processing functionality 1000 also includes an input/output module 1012 for receiving various inputs from a user (via input modules 1014), and for providing various outputs to the user (via output modules). One particular output mechanism may include a presentation module 1016 and an associated graphical user interface (GUI) 1018. The processing functionality 1000 can also include one or more network interfaces 1020 for exchanging data with other devices via one or more communication conduits 1022. One or more communication buses 1024 communicatively couple the above-described components together.

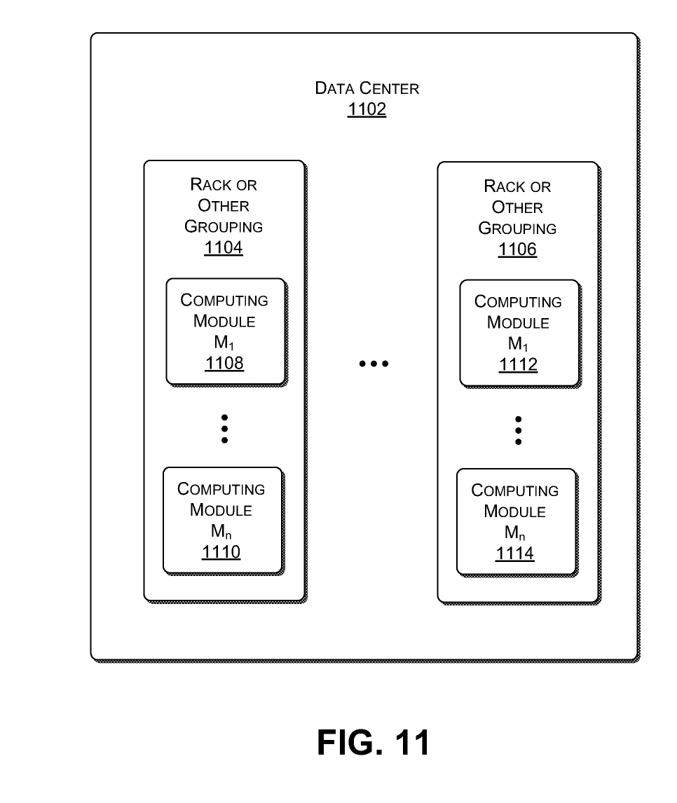

Finally, as mentioned above, the system 100 can be applied to manage a resource (such as power) in any computing environment, such as a data center. FIG. 11 shows one such data center 1102. The data center 1102 includes one or more groupings of computing modules, such as grouping 1104 and grouping 1106. For instance, these groupings (1104, 1106) may correspond to respective racks of computing modules within the data center 1102. Each grouping includes a collection of computing modules. For example, grouping 1104 includes computing module 1108 and computing module 1110, while grouping 1106 includes computing module 1112 and computing module 1114. These computing modules (1108, 1110, 1112, 1114) may implement any type of application or applications, such as server-related applications.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer readable medium for storing computer readable instructions, the computer readable instructions providing a system for managing power when executed by one or more processing devices, the computer readable instructions comprising:
logic configured to determine and apply power caps that govern operation of respective virtual machines in a computing environment, the power caps being determined based on a total amount of power that is available for use by the computing environment and bids received from the virtual machines,
a bid from each virtual machine expressing a request, made by the virtual machine, for an amount of power, the request being based on a quality-of-service expectation associated with the virtual machine.

2. The computer readable medium of claim 1, further comprising logic configured to generate an indication of the total amount of power that is available using a budget controller, the budget controller processing an error that expresses a difference between a consumption budget and a power measurement.

3. The computer readable medium of claim 1, further comprising logic, provided by the virtual machines, for determining the respective bids, each bid being based on a willingness value which reflects an assessed need for power by a corresponding virtual machine, together with a price which reflects congestion or overheads associated with allocating power to the corresponding virtual machine.

4. The computer readable medium of claim 1, wherein said logic configured to determine and apply power caps is configured to allocate an amount of power foregone by one or more virtual machines to one or more other virtual machines based on quality-of-service expectations.

5. A method for allocating a resource within a computing environment, comprising:
receiving a consumption budget that specifies a budgeted amount of the resource for use within the computing environment;
receiving a resource measurement that specifies an amount of the resource currently being consumed in the computing environment;
using a budget controller to provide, based on the consumption budget and the resource measurement, an indication of a total amount of the resource that is available for use by the computing environment;
determining, based on the total amount of the resource, allocations of resource for use by respective components within the computing environment; and
applying the allocations of resource to govern operation of the components.

6. The method of claim 5, wherein the consumption budget corresponds to a power consumption budget and the resource measurement corresponds to a measurement of an amount of power currently being consumed in the computing environment.

7. The method of claim 5, wherein the allocations of resource correspond to power caps that are used to respectively govern operation of the components.

8. The method of claim 5, wherein the components correspond to respective virtual machines.

9. The method of claim 8, wherein the virtual machines are used to implement applications, and wherein the computing environment corresponds to a data center.

10. The method of claim 8, wherein each virtual machine has at least one virtual processor associated therewith, and wherein a resource allocation for said at least one virtual machine corresponds to a power cap that is used to govern operation of said at least one virtual processor.

11. The method of claim 5, wherein the budget controller uses a proportional-derivative-integral approach to generate the indication of the total amount of the resource available.

12. The method of claim 5, wherein said determining further comprises:
receiving bids from respective components of the computing environment, the bid expressing requests, made by the components, for respective amounts of the resource; and
using the bids, together with the total amount of the resource that is available, to determine the allocations of resource for use by the respective components.

13. The method for claim 12, wherein each component generates a respective bid by:
receiving a price that reflects congestion or overheads associated with allocating the resource to the component;
receiving a willingness value which reflects an assessed need for the resource by the component, the assessed need being based on a quality-of-service expectation associated with the component; and
using a bid-generation controller to determine a bid based on the price and the willingness value.

14. The method of claim 13, wherein the bid-generation controller uses a proportional-derivative-integral approach to generate the bid.

15. The method of claim 13, further comprising generating updated prices and conveying the updated prices to the components.

16. A system for allocating a resource within a computing environment, comprising:
a main control module for managing one or more components within the computing environment, including:
logic configured to receive a consumption budget that specifies a budgeted amount of the resource for use within the computing environment;
logic configured to receive a resource measurement that specifies an amount of the resource currently being consumed in the computing environment;
logic configured to generate, based on the consumption budget and the resource measurement, an indication of a total amount of the resource that is available for use by the computing environment;
logic configured to receive one or more bids from said one or more components;
logic configured to determine, based on the total amount of the resource that is available and said one or more bids, allocations of resource for use by said one or more components within the computing environment;
logic configured to generate one or more prices for dissemination to said one or more components, each price reflecting congestion or overheads associated with allocating the resource to a component; and
logic configured to convey said one or more prices to said one or more respective components; and
a component, comprising a member of said one or more components, configured to run at least one application, including:
logic to receive a price from the main control module;
logic configured to receive a willingness value which reflects an assessed need for the resource by the component;
logic configured to determine a bid based on the price and the willingness value, the bid expressing a request for an amount of the resource; and
logic configured to convey the bid to the main control module.

17. The system of claim 16, wherein the consumption budget corresponds to a power consumption budget and the resource measurement corresponds to a measurement of an amount of power currently being consumed in the computing environment.

18. The system of claim 16, wherein the allocations of resource correspond to power caps that are used to govern operation of said one or more components.

19. The system of claim 16, wherein said one or more components correspond to one or more respective virtual machines.

20. The system of claim 16, further comprising a virtual machine management module configured to manage the allocations of resource among said one or more components.
